(19) United States
(12) Patent Application Publication
(10) Pub. No.: US 2014/0008391 A1
(43) Pub. Date: Jan. 9, 2014

(54) DUAL-AGENT SYRINGE

(71) Applicant: Ivy LIN, Kaohsiung City (TW)

(72) Inventor: Ivy LIN, Kaohsiung City (TW)

(21) Appl. No.: 13/540,621

(22) Filed: Jul. 3, 2012

(51) Int. Cl. B67D 7/70; B65D 47/04

(52) U.S. Cl. 222/136; 222/145.1

(57) ABSTRACT

The syringe contains an outer barrel, a compressible inner barrel threading through a support ring inside the outer barrel, and a plunger sealing the back of the outer barrel. The outer barrel has a hollow cylindrical body with an outer orifice at a front end. Inside the outer orifice, a positioning ring is provided whose circumference is configured with parallel ribs so that a number of channels are formed. The inner barrel has a bellows structure capable of being compressed and stretched along the axial direction. A tubular inner orifice is configured at a front end of the bellows structure. The plunger has a cylindrical shape. On a front side of the plunger, there is an axial chamber in the center surrounded by a push surface. Along the circumference of the plunger, there is at least a circling rib. The syringe could be applied to an ordinary adhesive gun.

### TECHNICAL FIELD OF THE INVENTION

The present invention is generally related to syringes, and more particularly to a syringe holding both main and curing agents capable of being applied to an ordinary adhesive gun.

### DESCRIPTION OF THE PRIOR ART

Anchor adhesives are commonly applied at construction sites. An anchor adhesive is usually injected into a drilled hole to fix a steel bar subsequently inserted. The anchor adhesive contains two major components: a main agent (or, A agent) made of organic synthetic resin taking up a greater portion and a secondary curing agent (or, B agent) taking up a smaller portion for speeding up the solidification of the anchor adhesive. As shown in FIG. 1, a conventional syringe for injecting anchor adhesive mainly contains a main barrel 11 holding the main agent (A agent) and a secondary barrel 12 holding the curing agent (B agent), both connected to a common orifice 13 fitted with a tube 14 having an internal spiral structure. The syringe has to be applied with a specialized adhesive gun pushing both the main and curing agents simultaneously out of the orifice 13 and, as they pass through the tube 14, they are mixed together.

The syringe and the specialized adhesive gun have to be compatible so as to work with each other. The syringe cannot be applied to those commonly used silicone gun and the specialized gun cannot work with other types of adhesive containers, which is rather inconvenient and troublesome.

### SUMMARY OF THE INVENTION

Therefore, a major objective of the present invention is to provide a novel syringe holding both main and curing agents and capable of being applied to an ordinary adhesive gun.

To achieve the objective, the syringe contains an outer barrel, a compressible inner barrel, a plunger, and a support ring. The outer barrel has a hollow cylindrical body with an outer orifice at a front end. Inside the outer orifice, a positioning ring is provided whose circumference is configured with a number of parallel ribs so that a number of channels along the front-to-back direction are formed. The compressible inner barrel is threaded through the support ring and the two are placed inside the outer barrel. The inner barrel has a bellows structure capable of being compressed and stretched along the axial or front-to-back direction with the confinement of the support ring. A tubular inner orifice is configured at a front end of the bellows structure. The plunger is also placed inside the outer barrel and has a cylindrical shape. On a front side of the plunger, there is an axial chamber in the center surrounded by a push surface. Along the circumference of the plunger, there is at least a circling rib to enhance the tightness between the plunger and the outer barrel.

The syringe's dimensions are similar to those of an ordinary silicone, single-agent syringe and the syringe of the present invention therefore could be applied to an ordinary adhesive gun. When the adhesive gun is engaged, a pushing rod of the adhesive gun forces the plunger to move forward. The main agent and the curing agent are pushed simultaneously through the channels and the inner orifice, respectively. The two agents are then mixed together as they flow through a tube fitting on the outer orifice.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side-view diagram showing a conventional syringe for anchor adhesives.

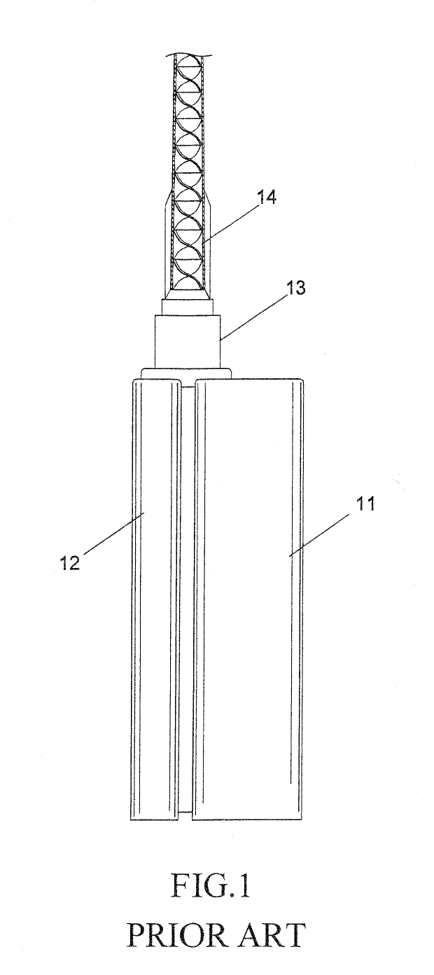

FIG. 2 is a perspective break-down diagram showing the various components of a dual-agent syringe according to an embodiment of the present invention.

FIG. 3 is a sectional diagram of the dual-agent syringe of FIG. 2.

FIG. 4 is a sectional diagram showing a plunger being pushed forward inside the dual-agent syringe of FIG. 2.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

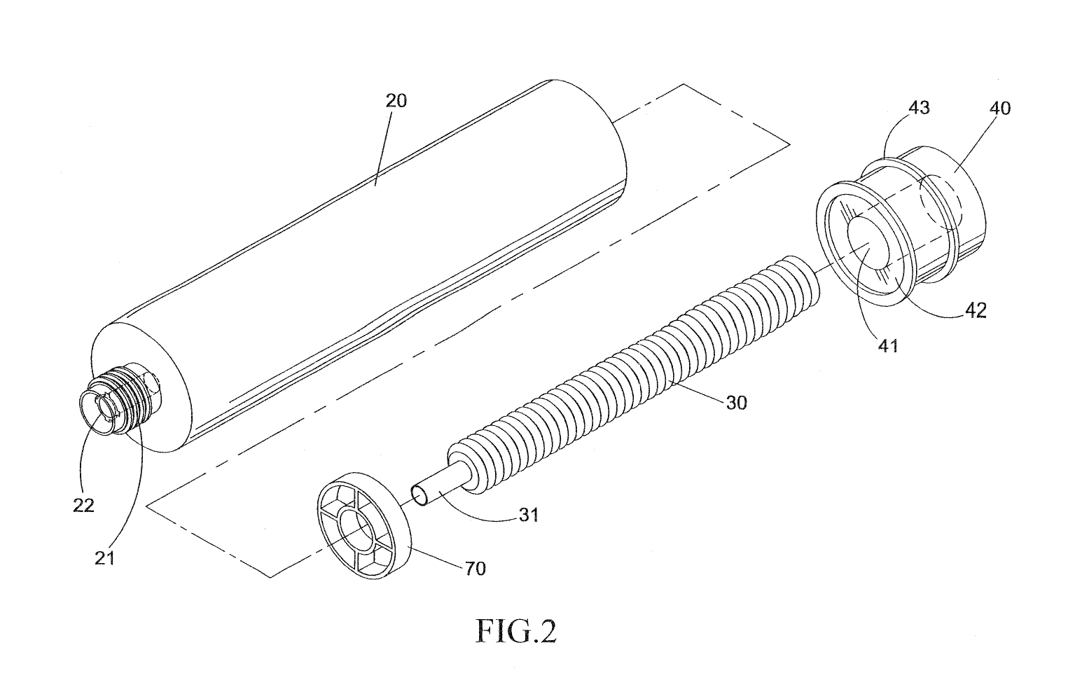

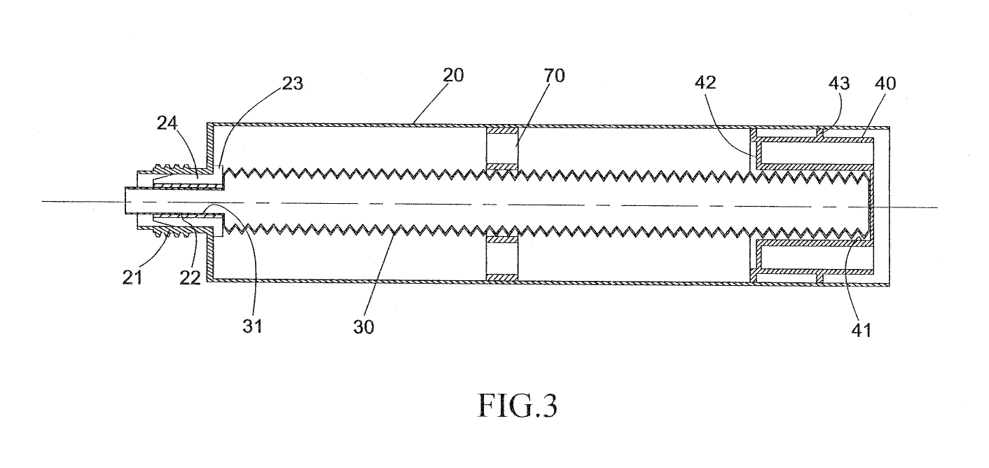

As shown in FIGS. 2 and 3, a dual-agent syringe according an embodiment of the present invention contains an outer barrel 20, a compressible inner barrel 30, a plunger 40, and a support ring between the outer and inner barrels 20 and 30.

The outer barrel 20 has a hollow cylindrical body whose dimensions are similar to those of an ordinary silicone, single-agent syringe. The dual-agent syringe of the present invention therefore could be applied to an ordinary adhesive gun. An outer orifice 21 is configured at a front end of the outer barrel 20 and an opening is configured at a back end. Inside the outer orifice 21, there is a positioning ring 22 whose circumference is configured with a number of parallel ribs 23 so that a number of channels 24 along the front-to-back direction are formed.

The compressible inner barrel 30 is placed inside the outer barrel 20 through the opening of the outer barrel 20 and has a bellows structure capable of being compressed and stretched along the axial or front-to-back direction. At a front end of the bellows structure, the inner barrel 30 has a tubular inner orifice 31 inserted in he positioning ring 22 of the outer orifice 21.

The plunger 40 is placed at the opening inside the outer barrel 20 and has a cylindrical shape. On a front side of the plunger 40, there is an axial chamber 42 in the center surrounded by a push surface 42. Along the circumference of the plunger 40, there is at least a circling rib 43 to enhance the tightness between the plunger 40 and the outer barrel 20.

The support ring 70 has a central opening. The diameter of the support ring is slightly smaller than the outer barrel 20. The diameter of the central opening is slightly larger than the inner barrel 30. As such, the inner barrel 30 is plugged into the support ring 70 and the two are altogether placed inside the outer barrel 20. With the help of the support ring 70, the compression of the inner barrel 30 is confined along the axial direction.

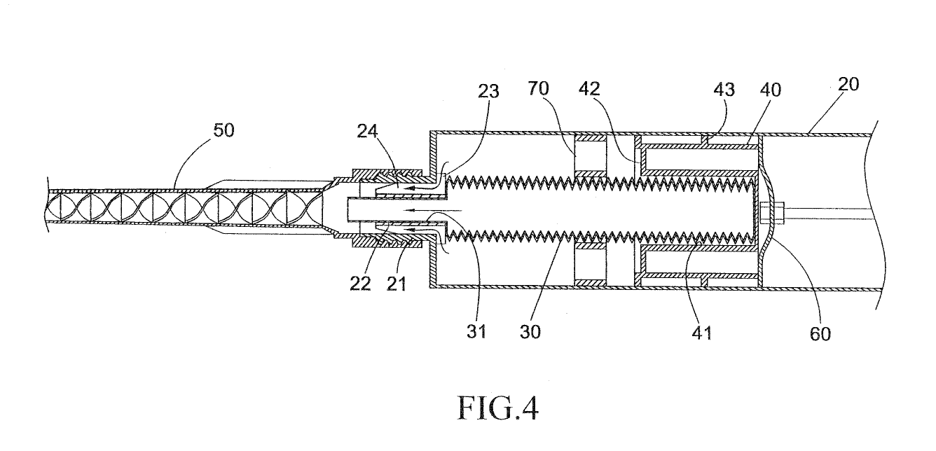

The curing agent is stored in the inner barrel 30, the inner barrel 30 is threaded through the support ring 70, and the two are place into the outer barrel from its opening at the back end. The inner orifice 31 is plugged into the positioning ring 22 of the outer orifice 21. The gap between the outer barrel 20 and the inner barrel 30 is filled with the main agent. The plunger 40 seals the opening at the back end of the outer barrel 20 and a back end of the inner barrel 30 is plugged into the chamber 42 of the plunger 40. As shown in FIG. 4, when the dual-agent syringe is put to use, a tube 50 having an internal spiral structure is fitted on the outer orifice 21 and the dual-agent syringe is mounted on an ordinary adhesive gun. When the adhesive gun is engaged, a pushing rod 60 of the adhesive gun forces the plunger 40 to move forward. The main agent and the curing agent are pushed simultaneously through the channels 24 and the inner orifice 31, respectively. The two agents are then mixed together as they flow through the tube 50 and then applied to a drilled hole to secure a steel bar subsequently inserted.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dual-agent syringe, comprising:
an outer barrel having a hollow cylindrical body with an outer orifice at a front end, an opening at a back end, a positioning ring inside said outer orifice whose circumference is configured with a plurality of parallel ribs thereby forming a plurality of channels along the front-to-back direction;
a compressible inner barrel inside said outer barrel having a bellows structure capable of being compressed and stretched along the front-to-back direction;
a plunger inside and sealing said opening of said back end of said outer barrel, said plunger having a cylindrical shape with an axial chamber for receiving a back end of said inner barrel surrounded by a push surface and at least a circling rib along the circumference of said plunger; and
a support ring having a central opening, said support ring having a diameter slightly smaller than said outer barrel's diameter, said central opening having a diameter slightly larger than said inner barrel, said inner barrel threading through said support ring, said support ring therefore positioned between said outer and inner barrels.

2. The dual-agent syringe according to claim 1, wherein said outer barrel's dimensions are the same as those of an ordinary silicone, single-agent syringe.
